(19) United States
(12) Patent Application Publication
(10) Pub. No.: US 2012/0114123 A1
(43) Pub. Date: May 10, 2012

(54) METHOD FOR SECURELY BROADCASTING SENSITIVE DATA IN A WIRELESS NETWORK

(75) Inventors: Oscar Garcia Morchon, Eindhoven (NL); Klaus Kursawe, Eindhoven (NL)

(73) Assignee: KONINKLIJKE PHILIPS ELECTRONICS N.V., EINDHOVEN (NL)

(21) Appl. No.: 13/384,016

(22) PCT Filed: Jul. 9, 2010
(86) PCT No.: PCT/IB2010/053144

§ 371 Date: Jan. 13, 2012

(30) Foreign Application Priority Data
Jul. 15, 2009 (EP) 09305676.0

(51) Int. Cl. H04L 9/00; H04W 12/00

(52) U.S. Cl. 380/270

(57) ABSTRACT

The invention relates to a method for securely broadcasting sensitive data in a wireless sensor networks comprising a central device, called trust center, and a plurality of sensor nodes, the trust center being initialized with a cryptographic hash chain and each node being initialized with a node key and the anchor of the trust center hash chain, the method comprising the following steps: the trust center broadcasting a first secure message to the nodes, each node, after reception of the first message, creating a first acknowledgment message, and transmitting it back to the trust center, the trust center checking whether all the nodes have transmitted respective first acknowledgment message, and in case all messages have been received, the trust center securely broadcasting sensitive data in a third message, the nodes checking, based on elements included in the first message, whether sensitive data actually originates from the trust center.

### FIELD OF THE INVENTION

The present invention relates to a method for ensuring secure broadcasting of data in a wireless network, more specifically in a wireless sensor network.

This invention is, for example, relevant for securing over-the-air software update in networks of the like.

### BACKGROUND OF THE INVENTION

Wireless sensor networks (WSNs), for example ZigBee networks, comprise a large number of resource-constrained sensors and actuators communicating through wireless links. These devices are, for example, constrained in terms of power, memory, or transmission rates. WSNs are used in many applications such as patient monitoring, home automation, smart energy, or lighting systems. In all these applications, it is quite useful to get the opportunity to transmit data in a secure way from a trust center of the network to the different nodes. Indeed, such opportunity would make it possible, for example, to update the software running on the different nodes, in order to include additional applications, solve problems or introduce more efficient protocols. In networks of the like, it is highly advantageous that new software can be installed from time to time while minimizing the impact on the deployed network.

However, existing methods for secure data broadcast over a network fails at fulfilling specific requirements of wireless sensor networks, which impose to:
manage the specific physical requirements of network of the like, such as a reduced amount of bandwidth, the resource—constrained nature of the sensor nodes regarding energy and CPU, the distributed nature of the network, and the involved operational requirements,
while maintaining a high level of security, which is a key feature when talking about software updates. Indeed, if an attacker would manage to inject a fake software into a node, then he would get control over the whole network, retrieve valuable information, or carry out a denial of service attack with unforeseeable consequences.

Existing methods include, for example, the use of public-key cryptography, which allows getting the required security level. Indeed, in such methods, the base station of a wireless sensor network signs a new software update with its private key before broadcasting it. Then the nodes in the network can verify the origin of the software by checking the authenticity of the signature. However, these methods are computationally too expensive for sensor networks. Besides, they require additional memory for the underlying security primitives and protocols. Moreover, the secure protocol for software updates must fit the expected system operation. That means that the sensor nodes and wireless connections should not suffer from high storage requirements or transmission overhead.

### SUMMARY OF THE INVENTION

It is an object of the invention to propose a method for securely broadcasting data over a wireless network, overcoming the drawbacks above-mentioned.

More precisely, it is an object of the invention to propose a method for broadcasting data while respecting the physical and security requirements of the network.

It is another object of the invention to provide a method for performing software network over-the-air in a secure way.

Yet another object of the invention is to provide a software update protocol ensuring low storage requirements until the software update actually starts.

Yet another object of the invention is to provide a method for managing memory to avoid rewriting the whole memory of a node when updating software.

Still another object of the invention is to propose a complete protocol for securing communication, transmitting the software update and performing secure activation of the software.

Yet another object of the invention is to provide a method to find out non-cooperative nodes, e.g., compromised nodes, disturbing an expected protocol operation.

To this end, the invention proposes a method for securely broadcasting sensitive data in a wireless sensor network comprising a central device, called trust center, and a plurality of sensor nodes, the trust center being initialized with a cryptographic hash chain and each node being initialized with a node key and the anchor of the trust center hash chain, the method comprising the following steps:
the trust center broadcasting a first secured message to the nodes,
each node, after reception of the first message, creating a first acknowledgment message, and transmitting it back to the trust center,
the trust center checking whether all the nodes have transmitted respective first acknowledgment message, and in case all messages have been received,
the trust center securely broadcasting sensitive data,
the nodes checking, based on elements included in the first message, whether sensitive data actually originates from the trust center.

The proposed protocol, or method, includes a hash chain owned by the trust center. This hash chain is used to disclose in a fully asynchronous form the future software updates. In the first step, the trust center discloses an update and all the nodes can make sure that the received pre-MAC is correct as it is disclosed together with an unknown value of the hash chain. In a second step, the trust center makes sure that all the nodes got the correct pre-MAC as the nodes reply with an ACK. Once the trust center has verified that all the nodes got the first message, the trust center discloses the software to be updated. The nodes can verify the software since they already got the pre-MAC.

Such approach is valid for a number of routing protocols such as mesh and tree routing protocols. In a mesh routing protocol, the trust center might get several combined pre-ACKs from several routers. In a tree-based routing protocol, the trust center would get only combined pre-ACKs from the nodes at level one of the tree. In most embodiments, the routers at level 1 aggregate the confirmation messages coming from the nodes or routers at level 1+1.

Moreover, if the network is protected by a network key, all the communications for software update should be protected by means of the network key. This prevents external attackers from introducing forge information.

In an embodiment of the invention, the network further comprises a router device connected to a plurality of nodes, and wherein the step of the nodes transmitting a first acknowledgment message to the trust center comprises:
each node transmitting a first acknowledgment message to the router device,
the router device combining the messages to create a complete first acknowledgment message, and
the router device transmitting the complete first acknowledgment message to the trust center.

The use of combined ACKs reduces the communicational overhead. If the trust center gets a wrong message, the protocol includes the capability of discovering the non-cooperative nodes. To this end, the trust center divides the network to find the wrong node. For instance assuming the network depicted in FIG. 1 and assuming that the combined pre-ACK is not valid, the trust center might ask router 1 and router 2 to send their combined pre-ACKs directly to him so that it can find out the part of the network that is introducing the wrong behavior. This approach can be further extended by applying a binary search.

In a preferred embodiment of the invention, a Merkle tree is used for minimizing communication overhead, in case the data to be transmitted is large. The Merkle tree is built as follows:
sensitive data is divided into several subsets,
the hash function of each subset is calculated,
the hash function of each subset is considered as leaves of a hash tree, and deriving the nodes and the root of the hash tree.

In such a case, the method is as follows:
the step of broadcasting a first message to the nodes comprises broadcasting the root of the hash tree, and
the step of broadcasting sensitive data comprises transmitting the nodes and root of the hash tree.

It can be noted here that the step of broadcasting sensitive data can be carried out over a long period of time as nodes only have to make sure that they receive the messages completing the sensitive data.

In another embodiment, the step of broadcasting sensitive data comprises broadcasting only nodes of the hash tree that are impacted by a modification as compared with the sensitive data previously sent.

In another embodiment, the first message comprises:
the element of the trust center hash chain situated immediately after the last transmitted element, called the next element, and
the hash function of the sensitive data to be broadcasted, concatenated with the last transmitted element of the hash chain.

In another embodiment, sensitive data to be transmitted corresponds to code image of a software, or of a software update.

In another embodiment, the method comprises the final step for the trust center, of broadcasting to the nodes a message for activating software in a uniform way.

In yet another embodiment of the invention, memory of the nodes are divided in memory pages, the method comprising the initial step of dividing sensitive data into several data subsets shorter than the length of the memory pages.

These and other aspects of the invention will be apparent from and will be elucidated with reference to the embodiments described hereinafter.

### BRIEF DESCRIPTION OF THE DRAWINGS

The present invention will now be described in more detail, by way of example, with reference to the accompanying drawings, wherein:

FIG. 1 represents a network carrying out a method according to the invention,

FIG. 2 shows a Merkle tree, and

FIG. 3 shows a secure incremental software update.

### DETAILED DESCRIPTION OF THE INVENTION

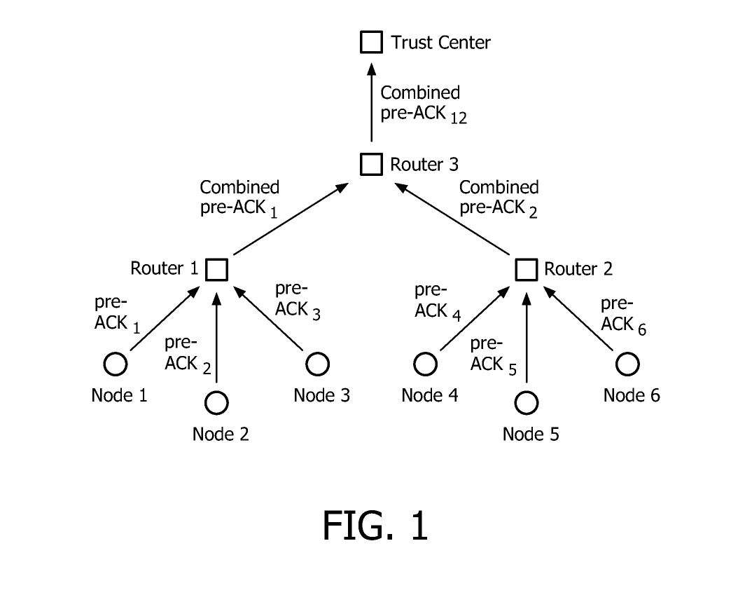

The present invention relates to a method for securely broadcasting software in a wireless sensor networks as shown in FIG. 1.

This network comprises a base station 1, or trust center, and resource-constrained nodes (node 1, node 2, node 3 . . . node 6).

The trust center manages the system security, and has the ability to receive and verify the new software image for the sensor node. Communication between the trust center and the resource-constrained nodes is performed by using a routing protocol, for example a mesh or tree-based protocol. In such a case, the network also comprises routers (router 1, router 2 and router 3) for relaying communication between the trust center and the nodes.

The communication protocol carried out in a network according to the invention requires initialization of the different devices of the network as follows:
The trust center comprises a hash chain {h_{N}^{TC}, h_{N-1}^{TC}, . . . , hᵢ^{TC}, hᵢ₋₁^{TC}, . . . , h₀^{TC}} such that hᵢ^{TC}=hash(hᵢ₋₁^{TC}). The values h₀^{TC} and h_{N}^{TC} are the seed and anchor of this hash chain, respectively,
Node keys are assigned to each node, wherein each key Kⱼ is a key shared between the trust center and node j,
Each node is also initialized with the anchor of the trust center hash claims. This secret can also be transmitted in a secure way from the trust center to each of the nodes during system operation.

Initialization of the memory of the nodes will be further detailed.

In case the transmission of sensitive data M corresponds to a complete software update, the protocol comprises three phases:
In a first phase, the trust center makes sure that all the nodes of the network have received a valid signature for the new software update. This signature is used by the node for authenticating the origin of a message,
In a second phase, the new software is securely broadcasted towards all nodes in the network, and
In a third phase, the software is activated in a synchronized and authenticated way.

In an embodiment, each of the phases is signed by means of a hash chain element.

The first phase consists in the trust center transmitting a valid signature for software signature, and checking whether all nodes have correctly received it.

Thus, in a first step, the trust center broadcast a message including the next element of the trust center hash chain hᵢ^{TC} and the hash of the new code image M concatenated with the next element of the same hash chain hᵢ₋₁^{TC}. This last element is used by the nodes to make sure that the received pre-MAC (i.e., the hash) is a good one and nobody has modified it.

Message 1:: hᵢ^{TC}, hash(hᵢ₋₁^{TC}|M)

Within the meaning of the present invention, the “next element” designates the element situated immediately after the current element in the hash chain, when going toward the seed (or root) of the chain.

Then, in a second step, the node, after reception of Message 1, creates a pre-ack Pre−ACKⱼ=hash(Kⱼ∥Message 1). A node only generates the pre-ack if the received message was sent together with a valid hᵢ^{TC}. The pre-ack can also be generated by encrypting Message 1 with Kⱼ

In a particular embodiment, the node does not transmit directly the pre-ack message to the trust center, but transmits it to a router which then combines several pre-acks from several end-devices and creates a combined pre-ack to be sent to other routers or directly to the trust center.

In this case, the node sents to the router a message 2.1:

pre−ACKⱼ=hash(Kⱼ|Message 1)

The router combines different messages as follows:

hash(Pre−ACKⱼ_{₁}|Pre−ACKⱼ_{₂}_{|}. . . |Pre−ACKⱼ_{_{M}}),j₁,j₂, . . . ,j_{M}

If the pre-ack is generated by means of an encryption function, the combined pre-ack can also be generated by encrypting the pre-acks with the key of the router. A further approach refers to the use of homomorphic encryption primitives.

In a third step, the trust center checks whether all the nodes have confirmed the reception of the pre-MAC. This checking completes the first phase as previously mentioned.

The second phase of the procol corresponds to the broadcast of the software itself Since the trust center has checked the correct reception by all nodes, then the trust center discloses the message together with the next element of the Trust Center hash chain.

Thus message 3 is as follows: hᵢ₋₁^{TC}, M. The nodes can check that the received message was generated by the trust center since they own the pre-MAC hash(hᵢ₋₁^{TC}|M). Thus, the nodes can securely deal with the message, for example if the message actually represents the code image of a piece of software, the nodes can install the software.

In case any confirmation from nodes would not have been received after some timeout, the protocol may enter an exception mode and proceed with the nodes that did confirm. If a wrong value is found, the system can proceed to find out the misbehaving nodes by carrying out a method that will be further described.

After reception of Message 3, a node creates an acknowledgment message ACKⱼ=hash(Message 3|Kⱼ) and sends it back to the trust center, directly or via a router. In case a router is used, the router combines several ACKs from several WSN nodes (or end-devices) and create a combined ACK. The router sends it to other routers or directly to the trust center.

hash(Pre−ACKⱼ_{₁}|Pre−ACKⱼ_{₂}_{|}. . . |Pre−ACKⱼ_{_{M}}),j₁,j₂, . . . ,j_{M}

In some embodiments, message 3 might be very large. Thus, in such a case, the nodes might send, instead, ACKⱼ=hash(Message 1|Kⱼ) as Message 1 is the fingerprint of Message 3. The node might also send ACKⱼ=hash(Message 3_{first bytes}|Kⱼ) where Message 3_{first bytes} refers to the first bytes of message3.

Phase two of the protocol is then completed, since the sensitive data has been correctly transmitted to each node, and acknowledgment messages have been sent back.

The third phase of the method is entirely optional, since it depends on the type of transmitted data. In case of a software update, the trust center may send a secure broadcast message to all the nodes in the network to activate the new software in a uniform way.

In order to make sure that this message is sent by the trust center and not by attackers trying to carry out a denial of service attack by trying to get nodes in the network with different software versions, the trust center discloses the next value of the hash chain hᵢ₋₂^{TC} together with this value. In this way, if a node gets the activation message, the node first verifies that the attached hash value is correct. If two nodes talk to each other, they can further verify their software versions. If they are different, the node with the newest software version might forward to the second party the software activation message. The second node can verify the validity of the message as explained above.

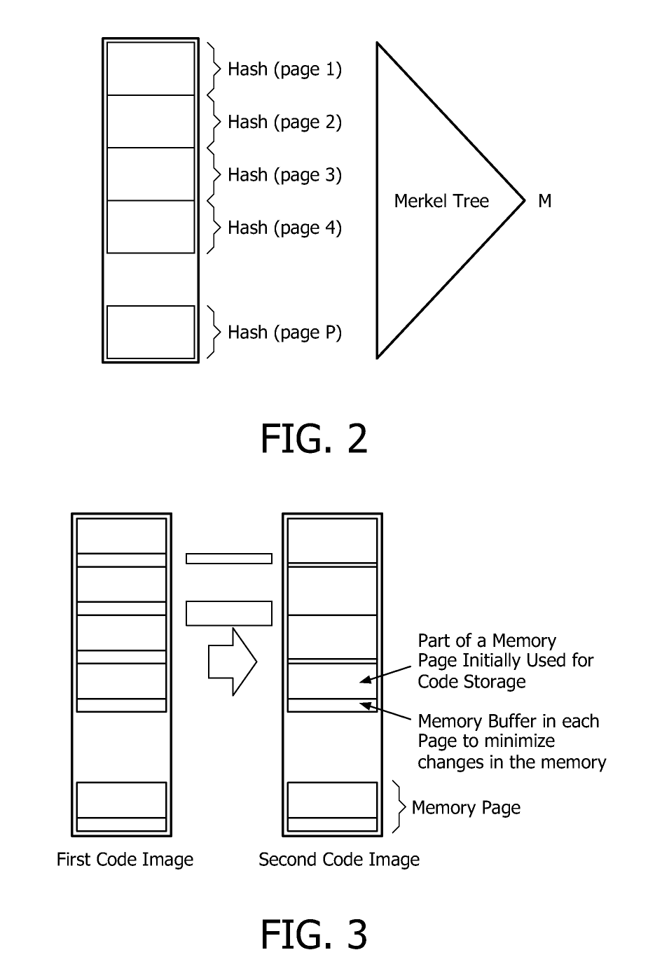

The complete protocol herein described allows a trust center in a network to make sure that a message is received in a secure way by all the nodes in a network. However, in case of software update, as said before, this message might be very large, and thus might lead to communication overhead. In order to solve this issue, in a particular embodiment of the invention, it has been decided to make use of a Merkel tree, or hash tree, as shown in FIG. 2. This tree is built as follows:

the code image of the software, or software update, is divided into different pages (page 1, page 2 . . . Page P), stored in different memory spaces,

the trust center performs calculation of the hash function of each of the memory pages; these values represent the leaves of a Merkel tree,

then, the trust center calculates the root M of the Merkel tree.

The method for software update using the Merkel tree is then similar to the one previously described, with the following amendments:

in message 1, M is not the entire message, but only the root of the Merkel tree,

in message 3, the root of the tree is disclosed together with all the nodes of the Merkle tree. Thus, if all nodes in the tree are disclosed, the trust center can broadcast the new software. The nodes reply with an ACK after verifying that the Merkle tree generated from disclosed software update matches the root of the Merkle tree (disclosed in message three and verified by means of the pre-MAC).

Such approach is highly advantageous for wireless sensor networks such as ZigBee sensor networks, because the system can be easily extended with the messages described in the above section that allow for the secure disclosure of the root of the Merkle tree. The rest of the messages of the software update can be disclosed by using existing primitives.

In a wireless network such as WSNs, software is regularly updated via incremental updates. Such update allows reducing the amount of information broadcast in the network. However, this approach presents major drawbacks when it comes to authenticate and verify software on the node side. Indeed, a software update generally consists in a small modification of one or several parts of the code, or the image of the code. Such a modification, even small, leads to a modification on all of the memory pages of the node. Accordingly, in order to verify the received data, it is then required to compute an update hash function for each page, and then to recalculate the whole tree to get an updated root. This heavy computation leads to a decrease in the performance of existing authentication schemes that are build in a page-by-page basis. Furthermore, this approach requires rewriting the whole memory, which is not recommended.

To overcome this issue, in one embodiment of the present invention, memory of the nodes is divided into B-byte long pages, but information is stored only in B′<B bytes.

Now, let us assume that a software update is required in which a few bytes are changed in the first and second page. If the system did not include the buffer of B′ bytes, the whole memory would need to be updated as the changes would propagate. Having the buffer of B′ overcomes this because as can be seen in FIG. 3, the changes are restricted to the local regions.

In the same manner, if the program code comprises a number of applications and software related to MAC, security, etc, we could divide the memory into several application sections. The pages used to store each of those applications would be configured as defined above (page of B bytes with buffer of B′ bytes), but additionally we would also include a few empty pages between applications to minimize memory changes when updating an isolated application.

In the context of the present invention, such memory management is highly advantageous in that a key advantage because only a few pages are modified, and thus only some of the nodes of the Merkle tree need to be resent. The system operation would be as follows. First, the trust center follows the steps as described before in the first phase, to disclose in a secure way the hash of the message (i.e., the whole memory). Then, the trust center discloses the partial update that allows for the incremental memory update. Third, the node reassembles its memory according to the disclosed messages. This should be done in an external memory before reprogramming. Once this is done, the node checks whether the resulting code leads to the same disclosed Merkle tree root by means of the Merkle tree structure.

It has been mentioned in the description of the method that, sometimes, it might occur that some nodes do not send back pre-ack messages in response to the first pre-Mac message. These nodes are thus considered as non-cooperative, but they can also be compromised. In such a case, it is useful to provide a feature for detecting compromised elements, in order to avoid any further compromising of other network elements.

Detecting a compromised node is not quite easy, especially in the case where communications between a node and the trust center are relayed via router, as shown on FIG. 1. Indeed, if only one node generates a wrong ACK or pre-ACK the routers would generate wrong combined ACKs or pre-ACKs. The trust center can try to verify the ACKs and pre-ACKs, but it will fail as any wrong value used in the generation of the combined value changes the final result.

To overcome this issue, in one embodiment of the present invention, to find out a non-cooperative node, the trust center divides the nodes contributing to a combined ACK or pre-ACKs into several segments. To this end, the base station (or trust center) sends a request to the involved routers. The routers would collect the ACKs or pre-ACKs from the nodes in the respective segment. In such a way, the trust center can find out which segments behave in the right way and which ones do not. The trust center can further carry out a binary search to exactly determine the compromised or misbehaving nodes

Accordingly, a combination of the different features disclosed in the present invention makes it possible to provide a method for updating software over-the-air in a secure way, while taking into account the physical restrictions of the sensor nodes of a WSN.

The present invention is more especially dedicated to medical sensor networks, lighting systems, smart energy, building automation, or any other application including distributed systems and sensor networks.

In the present specification and claims the word “a” or “an” preceding an element does not exclude the presence of a plurality of such elements. Further, the word “comprising” does not exclude the presence of other elements or steps than those listed.

The inclusion of reference signs in parentheses in the claims is intended to aid understanding and is not intended to be limiting.

From reading the present disclosure, other modifications will be apparent to persons skilled in the art. Such modifications may involve other features which are already known in the area of wireless sensor networks control and which may be used instead of or in addition to features already described herein.

1. A method for securely broadcasting sensitive data in a wireless sensor networks comprising a trust center, and a plurality of sensor nodes, the trust center being initialized with a cryptographic hash chain and each node being initialized with a node key and the anchor of the trust center hash chain, the method comprising:
the trust center broadcasting a first secure message to the nodes,
each node, after reception of the first message, creating a first acknowledgment message, and transmitting it back to the trust center,
the trust center checking whether all the nodes have transmitted respective first acknowledgment message, and in case all messages have been received,
the trust center securely broadcasting sensitive data in a third message,
the nodes checking, based on elements included in the first message, whether sensitive data actually originates from the trust center.

2. The method as recited in claim 1, wherein two hash chain elements are disclosed to secure the first and third messages.

3. The method as recited in claim 1, wherein the network further comprises a router device connected to a plurality of nodes, and wherein the step of the nodes transmitting a first acknowledgment message to the trust center comprises:
each node transmitting a first acknowledgment message to the router device,
the router device combining the messages to create a complete first acknowledgment message, and
the router device transmitting the complete first acknowledgment message to the trust center.

4. The method as recited in claim 1, further comprising:
dividing sensitive data into several subsets,
calculating the hash function of each subset,
considering the hash function of each subset as leaves of a hash tree, and deriving the nodes and the root of the hash tree.

5. The method as recited in claim 4, wherein
the step of broadcasting a first message to the nodes comprises broadcasting the root of the hash tree, and
the step of broadcasting sensitive data comprises transmitting the nodes and root of the hash tree.

6. The method as recited in claim 4 wherein, the step of broadcasting sensitive data comprises broadcasting only nodes of the hash tree that are impacted by a modification as compared with the sensitive data previously sent.

7. The method as recited in claim 1, wherein the first message comprises:
the element of the trust center hash chain situated immediately the last transmitted element, and
the hash function of the sensitive data to be broadcasted, concatenated with the last transmitted element of the hash chain.

8. The method as recited in claim 1, wherein sensitive data to be transmitted corresponds to code image of a software or of a software update.

9. The method as recited in claim 8, comprising broadcasting to the nodes a secure message for activating software in a uniform way.

10. The method as recited in claim 3, wherein a third element of the hash chain is used to securely activate the software.

11. The method as recited in claim 1, wherein three hash chain elements are disclosed for each secure software update.

12. The method as recited in claim 11, wherein each of the three hash chain elements is used for secure pre-acknowledge of the software, secure disclosure of the software, and secure activation of the software.

13. The method as recited in claim 1, wherein memory of the nodes are divided in memory pages, the method further comprising dividing sensitive data into several data subsets shorter than the length of the memory pages.

14. The method as recited in claim 1, wherein the network is divided into segments to find out non-cooperative nodes.
